(19) United States
(12) Patent Application Publication
(10) Pub. No.: US 2008/0003173 A1
(43) Pub. Date: Jan. 3, 2008

(54) PROCESSES FOR THE PREPARATION OF CHLORINE BY GAS PHASE OXIDATION, CATALYSTS THEREFOR, AND METHODS OF MAKING SUCH CATALYSTS

(75) Inventors: Aurel Wolf, Wolfrath (DE); Oliver Felix-Karl Schluter, Leverkusen (DE); Leslaw Mleczko, Dormagen (DE); Stephan Schubert, Leverkusen (DE); Jorgen Kintrup, Leverkusen (DE)

Correspondence Address: CONNOLLY BOVE LODGE & HUTZ, LLP, P O BOX 2207, WILMINGTON, DE, 19899, US

(73) Assignee: Bayer Material Science AG, Leverkusen (DE)

(21) Appl. No.: 11/752,398

(22) Filed: May 23, 2007

(30) Foreign Application Priority Data
May 23, 2006 (DE) 10 2006 024 546.6

(51) Int. Cl. C01B 7/04; B01J 21/18; B01J 23/42; B01J 23/46; B01J 27/02; B01J 27/045; B05D 3/00

(52) U.S. Cl. 423/502; 427/372.2; 502/182; 502/216; 502/223

(57) ABSTRACT

Processes for the preparation of chlorine by catalytic gas phase oxidation of hydrogen chloride with oxygen, wherein the catalyst comprises at least one support substance and at least one catalytic metal sulfide, catalysts which comprise at least one support substance and at least one catalytic metal sulfide, and processes for making the same.

### BACKGROUND OF THE INVENTION

A process for the catalytic oxidation of hydrogen chloride with oxygen in an exothermic equilibrium reaction, developed by Deacon in 1868, was at the beginning of industrial chlorine chemistry. However, the Deacon process was pushed into the background by chlor-alkali electrolysis. For some time, virtually the entire production of chlorine was by electrolysis of aqueous sodium chloride solutions (Ullmann's Encyclopedia of Industrial Chemistry, Seventh Release, 2006). However the attractiveness of the Deacon process has recently been increasing again, since worldwide demand for chlorine is growing faster than the demand for sodium hydroxide solution. Processes for the preparation of chlorine by oxidation of hydrogen chloride, which are unconnected with the preparation of sodium hydroxide solution, satisfy this development. Furthermore, hydrogen chloride is obtained as a by-product in large quantities, for example, in phosgenation reactions, as in the preparation of isocyanate.

The oxidation of hydrogen chloride to chlorine is an equilibrium reaction. The position of the equilibrium shifts to the disfavor of the desired end product as the temperature increases. It is therefore advantageous to employ catalysts with the highest possible activity, which allow the reaction to proceed at a low temperature.

The first catalysts developed for oxidation of hydrogen chloride contained copper chloride or oxide as the active component and had been described by Deacon in 1868. However, these had only low activities at lower temperatures (<400° C.). By increasing the reaction temperature, it was possible to increase the activity, but a disadvantage was that the volatility of the active components at higher temperatures led to a rapid decrease in the activity of the catalyst.

The oxidation of hydrogen chloride with catalysts based on chromium oxides is also known. However, processes catalyzed in this way can have an inadequate activity and can require high reaction temperatures.

Catalysts for the oxidation of hydrogen chloride containing the catalytically active component ruthenium are also known. For example, RuCl₃ supported on silicon dioxide and aluminium oxide has been described. However, the activity of such RuCl₃/SiO₂ catalysts can be very low. Further Ru-based catalysts with the active mass of ruthenium oxide or ruthenium mixed oxide and various oxides, such as e.g., titanium dioxide, zirconium dioxide etc., as the support material have been described. The content of ruthenium oxide can be 0.1 wt. % to 20 wt. % and the average particle diameter of ruthenium oxide can be 1.0 nm to 10.0 nm. Ru catalysts supported on titanium dioxide or zirconium dioxide are also known. A number of Ru starting compounds, such as e.g., ruthenium-carbonyl complexes, ruthenium salts of inorganic acids, ruthenium-nitrosyl complexes, ruthenium-amine complexes, ruthenium complexes of organic amines or ruthenium-acetylacetonate complexes, have been mentioned for the preparation of the ruthenium chloride and ruthenium oxide catalysts described therein which contain at least one compound of titanium oxide and zirconium oxide. TiO₂ in the rutile form has been employed as a support. Ruthenium oxide catalysts can have a quite high activity, but the use thereof is expensive and can require a number of operations, such as precipitation, impregnation with subsequent precipitation etc., scale-up of which is difficult industrially. In addition, at high temperatures ruthenium oxide catalysts also tend towards sintering and thus towards deactivation.

Supported catalysts based on gold have also been described. A higher activity of gold, compared with Ru catalysts, at low temperatures (<250° C.) has been suggested as an advantage; however, this is not known to be demonstrated by data or examples.

Catalysts developed to date for Deacon processes have a number of inadequacies. At low temperatures, the activity thereof is inadequate. It is possible to increase activity by increasing reaction temperature, but this can lead to sintering/deactivation or to a loss of the catalytic component. Furthermore, conventional catalysts may react sensitively to traces of sulfur in the feed gas stream.

### SUMMARY OF THE INVENTION

One object of the present invention is to provide a catalytic system which can effect the oxidation of hydrogen chloride at low temperatures, preferably with high activities and a low sensitivity to sulfur in the feed gas stream.

It has surprisingly been found that supported metal sulfide catalysts can exhibit excellent activity in the catalytic gas phase oxidation of hydrogen chloride with oxygen at low temperature.

The invention relates, in general, to processes for the preparation of chlorine by catalytic gas phase oxidation of hydrogen chloride with oxygen, and to novel catalysts for such processes. Thus, the invention also relates to catalysts which comprise at least one support substance and at least one catalytic metal sulfide.

One embodiment of the present invention includes a process which comprises providing a gas phase comprising hydrogen chloride and oxygen; and oxidizing the hydrogen chloride with the oxygen in the presence of a catalyst, wherein the catalyst comprises a catalytic metal sulfide on a support substance.

Another embodiment of the present invention includes a process which comprises applying an aqueous form of a catalytic metal sulfide to a support substance to provide a catalyst precursor, and subjecting the catalyst precursor to a treatment selected from the group consisting of drying, calcining, and combinations thereof. An additional embodiment of the present invention include a product made by such a process.

Another embodiment of the present invention includes a process which comprises providing an aqueous mixture of a substantially sulfur-free catalyst metal compound and a support substance, contacting the mixture with a metal sulfide to precipitate a catalyst precursor, and subjecting the catalyst precursor to a treatment selected from the group consisting of drying, calcining, and combinations thereof. An additional embodiment of the present invention include a product made by such a process.

Another embodiment of the present invention includes a composition which comprises a catalytic metal sulfide on a support substance. In various preferred embodiments of the present invention, the catalytic metal sulfide comprises ruthenium.

### DETAILED DESCRIPTION OF THE INVENTION

A support substance suitable for use in the various embodiments of the invention is preferably chosen from a group which is comprised of oxides and mixed oxides of metals or semi-metals, such as titanium oxides, tin oxides, aluminium oxides, zirconium oxides, silicon oxides, magnesium oxide, titanium mixed oxides, zirconium mixed oxides, aluminium mixed oxides and silicon mixed oxides, and carbon black and carbon nanotubes. Carbon nanotubes have an advantage over carbon black in that they are considerably more stable to oxidation at higher temperatures. In various preferred embodiments, tin(IV) dioxide, carbon black or carbon nanotubes can be employed as the support substance for a catalytically active component.

A suitable metal for inclusion as the catalytically active metal component of the catalytic metal sulfide can preferably be chosen from the group which is comprises of: Ru, Os, Cu, Au, Bi, Pd, Pt, Rh, Ir, Re and Ag and mixtures thereof. The following elements are more preferably suitable as a catalytically active metal of the catalyst metal sulfide: ruthenium, iridium and platinum, and even more preferably ruthenium in combination with iridium or platinum.

The loading of a catalytic metal sulfide on a support substance can generally be about 0.1-80 wt. %, preferably 1-50 wt. %, more preferably 1-20 wt. %, based on the amount of metal in the catalytic metal sulfide.

A catalytic metal sulfide can be applied to a support substance by various processes. For example, and without being limited thereto, moist and wet impregnation of a support with suitable starting compounds present in solution or starting compounds in liquid or colloidal form, precipitation and co-precipitation processes, and ion exchange and gas phase coating (CVD, PVD) can be employed. A combination of impregnation and subsequent precipitation with sulfidic (preferably sodium sulfide or hydrogen sulfide) substances is preferred.

In certain embodiments, a catalytic metal sulfide on a support substance can be prepared by applying an aqueous form of a catalytic metal sulfide to a support substance to provide a catalyst precursor; and subjecting the catalyst precursor to a treatment selected from the group consisting of drying, calcining, and combinations thereof.

In certain embodiments, a catalytic metal sulfide on a support substance can be prepared by providing an aqueous mixture of a substantially sulfur-free catalyst metal compound and a support substance; contacting the mixture with a metal sulfide to precipitate a catalyst precursor; and subjecting the catalyst precursor to a treatment selected from the group consisting of drying, calcining, and combinations thereof.

Examples of possible promoters for the application of catalytic component to the support are metals having a basic action (e.g., alkali-, alkaline earth- and rare earth metals). Alkali metals, in particular Na and Cs, and alkaline earth metals are preferred, and alkaline earth metals, in particular Sr and Ba, are particularly preferred.

The promoters can be applied to the catalyst by impregnation and CVD processes, without being limited thereto, and an impregnation is preferred, particularly preferably after application of the catalytic main component.

For stabilization of the dispersion of the catalytic main component on the support, various dispersion stabilizers, such as e.g., scandium oxides, manganese oxides and lanthanum oxides etc., can be employed without being limited thereto. The stabilizers are preferably applied by impregnation and/or precipitation together with the catalytic main component.

The stabilizers mentioned in general can also stabilize at high temperatures the specific surface area of the support employed.

In one embodiment the catalysts can be dried under normal pressure or, preferably, under reduced pressure, preferably at 40 to 200° C. The duration of the drying is preferably 10 min to 6 h.

Catalysts comprising at least one support substance chosen from carbon nanotubes, tin dioxide, titanium dioxide and carbon black and at least one catalyst metal sulfide chosen from ruthenium, iridium, platinum and rhodium and mixtures thereof are preferred. Catalysts wherein the catalyst metal sulfide is chosen from mixtures of Ru and Pt sulfides and Ru and Ir sulfides are particularly preferred.

The catalysts can be employed in the non-calcined or calcined form. The calcining can be carried out in a reducing, oxidizing or inert phase, and calcining is preferably carried out in a stream of air, oxygen or nitrogen, still more preferably under nitrogen. The calcining is carried out in a temperature range of from 150 to 600° C., preferably in the range of 200 to 300° C. The duration of the calcining is preferably 1-24 h. In the case of calcining under oxidizing conditions, the sulfur content of the metal sulfides may be reduced in favor of oxidic contents.

Preferably, catalysts in accordance with any of the various embodiments of the present invention are used, as already described above, in a catalytic process known as the Deacon process. In such processes, hydrogen chloride is oxidized with oxygen in an exothermic equilibrium reaction to form chlorine, with the formation of steam. The reaction temperature is usually 150 to 500° C., and the normal reaction pressure is 1 to 25 bar. Since the reaction is an equilibrium reaction, it is appropriate to use the lowest possible temperatures at which the catalyst still has sufficient activity. It is also appropriate for oxygen to be used in superstoichiometric quantities in relation to the hydrogen chloride. A two- to four-fold oxygen excess is for example commonly used. Since no selectivity losses need to be feared, it can be economically advantageous to carry out the reaction at a relatively high pressure and an accordingly longer residence time than when using normal pressure.

The catalytic hydrogen chloride oxidation can be carried out adiabatically or preferably isothermally or approximately isothermally, or discontinuously, but preferably continuously in the form of a fluidized or fixed bed process, and preferably in the form of a fixed bed process, and particularly preferably in tube bundle reactors on heterogeneous catalysts at a reactor temperature of 180 to 500° C., preferably 200 to 400° C., particularly preferably 220 to 350° C. and a pressure of 1 to 25 bar (1000 to 25000 hPa), preferably 1.2 to 20 bar, particularly preferably 1.5 to 17 bar and in particular 2.0 to 15 bar.

Conventional reaction apparatuses in which the catalytic hydrogen chloride oxidation is carried out are fixed bed or fluidized bed reactors. Catalytic hydrogen chloride oxidation can preferably also be carried out in several stages.

For the adiabatic, isothermal or approximately isothermal mode of operation it is also possible to use more than one, i.e., 2 to 10, preferably 2 to 6, particularly preferably 2 to 5, and in particular 2 to 3 series-connected reactors with intermediate cooling. The oxygen can be added either completely together with the hydrogen chloride upstream of the first reactor or in a distributed manner over the various reactors. This series connection of individual reactors can also be combined in one apparatus.

An additional preferred variant of a device suitable for the process consists in using a structured catalyst bed in which the catalyst activity increases in the direction of flow. Such structuring of the catalyst bed can be obtained by varying the impregnation of the catalyst support with the active composition or varying the dilution of the catalyst with an inert material. The inert material used can for example be rings, cylinders or beads of titanium dioxide, zirconium dioxide or mixtures thereof, aluminium oxide, steatite, ceramics, glass, graphite or stainless steel. In the case of the preferred use of shaped catalysts, the inert material should preferably have similar external dimensions.

The conversion rate of hydrogen chloride in a single passage can preferably be limited to 15 to 90%, preferably 40 to 85%, and particularly preferably 50 to 70%. Any non-converted hydrogen chloride can be separated off and partially or completely recycled to the catalytic hydrogen chloride oxidation process. The volumetric ratio of hydrogen chloride to oxygen at the inlet of the reactor is preferably between 1:1 and 20:1, preferably between 2:1 and 8:1, and particularly preferably between 2:1 and 5:1.

The heat of reaction of the catalytic hydrogen chloride oxidation can advantageously be used for the production of high-pressure steam. This can be used for operating a phosgenation reactor or distillation columns, and in particular isocyanate distillation columns.

In an additional step the chlorine formed is separated off. The separation step usually comprises more than one stage, namely the separation and optional recycling of non-converted hydrogen chloride from the product gas stream of the catalytic hydrogen chloride oxidation, drying the resulting stream essentially containing chlorine and oxygen and separating chlorine from the dried stream.

The separation of non-converted hydrogen chloride and of steam which has formed can be carried out by condensing aqueous hydrochloric acid out of the product gas stream of the hydrogen chloride oxidation by cooling. Hydrogen chloride can also be absorbed in dilute hydrochloric acid or water.

The catalysts according to the invention for the oxidation of hydrogen chloride are distinguished by a high activity at low temperatures.

The following examples are for reference and do not limit the invention described herein.

### EXAMPLES

### Preparative Example 1

### Supporting of Ruthenium Sulfide on Carbon Black

10 g of carbon black (Vulcan XC72) were suspended in 450 ml water using ultrasound in a round-bottomed flask with a stirrer, reflux condenser and inlet tube for H₂S or nitrogen and outlet for waste gas, and a solution of 10 g of commercially obtainable ruthenium chloride n-hydrate in 45 ml of water was added and the mixture was stirred for 30 min while passing in nitrogen. A 40-fold excess of H₂S was then passed through the suspension over a period of 5 h. The excess hydrogen sulfide was driven off with nitrogen, and the solid was filtered off and washed several times with water. The moist solid was predried at 70° C. in vacuo and dried overnight at 100° C.

### Catalytic Test Examples

A gas mixture of 80 ml/min (STP) of hydrogen chloride and 80 ml/min (STP) of oxygen flowed through the catalyst from Example 1 in a packed fixed bed in a quartz reaction tube (diameter 10 mm) at 300° C. The quartz reaction tube was heated by an electrically heated fluidized bed of sand. After 30 min the product gas stream was passed into 16% strength potassium iodide solution for 10 min. The iodine formed was then back-titrated with 0.1 N thiosulfate standard solution in order to determine the amount of chlorine passed in. The sulfides shown in Table 1 were tested analogously. The amounts of chlorine listed in Table 1 resulted. Table 1 also lists the resulting activity for selected oxides which were tested in addition to the sulfides listed.

TABLE 1

| Catalyst | Formation of chlorine [mmol/min · g(cat)] |
|---|---|
| Ru-Sulfid/Vulcan XC72 | 0.103 |
| Re-Sulfid/Vulcan XC72 | 0.109 |
| Rh-Sulfid/Vulcan XC72 | 0.121 |
| Ru/Rh-Sulfid/Vulcan XC72 | 0.078 |
| Ru/Pt-Sulfid/Vulcan XC72 | 0.165 |
| Ru/Ir-Sulfid/Vulcan XC72 | 0.153 |
| Ir-Sulfid/Vulcan XC72 | 0.035 |
| Pd-Sulfid/Vulcan XC72 | 0.024 |
| Pt-Sulfid/Vulcan XC72 | 0.012 |
| Ag-Sulfid/Vulcan XC72 | 0.012 |
| Ru-Ox./Vulcan XC72 | 0.109 |
| Ir-Ox./Vulcan XC72 | 0.03 |
| Ir/Vulcan XC72 | 0.062 |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising:
(a) providing a gas phase comprising hydrogen chloride and oxygen; and
(b) oxidizing the hydrogen chloride with the oxygen in the presence of a catalyst, wherein the catalyst comprises a catalytic metal sulfide on a support substance.

2. The process according to claim 1, wherein the support substance comprises a material selected from the group consisting of oxides, mixed oxides, and combinations thereof.

3. The process according to claim 1, wherein the catalytic metal sulfide comprises a metal selected from the group consisting of Ru, Os, Cu, Au, Bi, Pd, Pt, Rh, Ir, Re, Ag, and combinations thereof.

4. The process according to claim 1, wherein the catalyst is prepared by a process comprising: applying an aqueous form of the catalytic metal sulfide to the support substance to provide a catalyst precursor; and subjecting the catalyst precursor to a treatment selected from the group consisting of drying, calcining, and combinations thereof.

5. The process according to claim 4, wherein the treatment is carried out under an inert atmosphere.

6. The process according to claim 4, wherein the catalyst precursor is subjected to drying and calcining.

7. The process according to claim 1, wherein the catalyst is prepared by a process comprising: providing an aqueous mixture of a substantially sulfur-free catalyst metal compound and the support substance; contacting the mixture with a metal sulfide to precipitate a catalyst precursor; and subjecting the catalyst precursor to a treatment selected from the group consisting of drying, calcining, and combinations thereof.

8. The process according to claim 7, wherein the catalyst precursor is subjected to drying and calcining.

9. The process according to claim 7, wherein the treatment is carried out under an inert atmosphere.

10. The process of claim 1, wherein the catalytic metal sulfide comprises ruthenium.

11. The process according to claim 1, wherein the support substance comprises a material selected from the group consisting of tin dioxide, carbon black, carbon nanotubes, and combinations thereof.

12. The process according to claim 1, wherein the oxidation of the hydrogen chloride is carried out at a reaction temperature of 450° C. or less.

13. A process comprising: applying an aqueous form of a catalytic metal sulfide to a support substance to provide a catalyst precursor; and subjecting the catalyst precursor to a treatment selected from the group consisting of drying, calcining, and combinations thereof.

14. A process comprising: providing an aqueous mixture of a substantially sulfur-free catalyst metal compound and a support substance; contacting the mixture with a metal sulfide to precipitate a catalyst precursor; and subjecting the catalyst precursor to a treatment selected from the group consisting of drying, calcining, and combinations thereof.

15. A composition comprising a catalytic metal sulfide on a support substance.

16. The composition according to claim 15, wherein the support substance comprises a material selected from the group consisting of carbon nanotubes, tin dioxide, titanium dioxide, carbon black, and combinations thereof, and wherein the catalytic metal sulfide comprises a metal selected from the group consisting of ruthenium, iridium, platinum, rhodium, and mixtures thereof.

17. The composition according to claim 15, wherein the catalytic metal sulfide comprises a ruthenium sulfide selected from the group consisting of Ru/Pt sulfides, Ru/Ir sulfides, and combinations thereof.

18. A composition prepared by the process according to claim 13.

19. A composition prepared by the process according to claim 14.
